(19) United States
(12) Patent Application Publication
(10) Pub. No.: US 2010/0208221 A1
(43) Pub. Date: Aug. 19, 2010

(54) FLUID SUPPLY SYSTEM, A LITHOGRAPHIC APPARATUS, A METHOD OF VARYING FLUID FLOW RATE AND A DEVICE MANUFACTURING METHOD

(75) Inventors: Pieter Jacob Kramer, Veldhoven (NL); Anthonie Kuijper, Best (NL); Arjan Hubrecht Josef Anna Martens, Valkenburg (NL)

Correspondence Address: PILLSBURY WINTHROP SHAW PITTMAN, LLP, P.O. BOX 10500, MCLEAN, VA, 22102, US

(73) Assignee: ASML NETHERLANDS B.V., Vendhoven (NL)

(21) Appl. No.: 12/706,518

(22) Filed: Feb. 16, 2010

Related U.S. Application Data
(60) Provisional application No. 61/153,216, filed on Feb. 17, 2009.

(51) Int. Cl. G03B 27/52; G03B 27/32

(52) U.S. Cl. 355/30; 355/77

(57) ABSTRACT

A fluid supply system for a lithographic apparatus, includes a controller configured to vary fluid flow rate to a first component from a fluid source while maintaining total flow resistance to fluid downstream of the fluid source substantially constant.

This application claims priority and benefit under 35 U.S.C. §119(e) to U.S. Provisional Patent Application No. 61/153,216, entitled “A Fluid Supply System, a Lithographic Apparatus, a Method of Varying Fluid Flow Rate and a Device Manufacturing Method”, filed on Feb. 17, 2009. The content of that application is incorporated herein in its entirety by reference.

### FIELD

The present invention relates to a fluid supply system, a lithographic apparatus, a method of varying fluid flow rate and a device manufacturing method.

### BACKGROUND

A lithographic apparatus is a machine that applies a desired pattern onto a substrate, usually onto a target portion of the substrate. A lithographic apparatus can be used, for example, in the manufacture of integrated circuits (ICs). In that instance, a patterning device, which is alternatively referred to as a mask or a reticle, may be used to generate a circuit pattern to be formed on an individual layer of the IC. This pattern can be transferred onto a target portion (e.g. comprising part of, one, or several dies) on a substrate (e.g. a silicon wafer). Transfer of the pattern is typically via imaging onto a layer of radiation-sensitive material (resist) provided on the substrate. In general, a single substrate will contain a network of adjacent target portions that are successively patterned. Known lithographic apparatus include so-called steppers, in which each target portion is irradiated by exposing an entire pattern onto the target portion at one time, and so-called scanners, in which each target portion is irradiated by scanning the pattern through a radiation beam in a given direction (the “scanning”-direction) while synchronously scanning the substrate parallel or anti-parallel to this direction. It is also possible to transfer the pattern from the patterning device to the substrate by imprinting the pattern onto the substrate.

It has been proposed to immerse the substrate in the lithographic projection apparatus in a liquid having a relatively high refractive index, e.g. water, so as to fill a space between the final element of the projection system and the substrate. In an embodiment, the liquid is distilled water, although another liquid can be used. An embodiment of the present invention will be described with reference to liquid. However, another fluid may be suitable, particularly a wetting fluid, an incompressible fluid and/or a fluid with higher refractive index than air, desirably a higher refractive index than water. Fluids excluding gases are particularly desirable. The point of this is to enable imaging of smaller features since the exposure radiation will have a shorter wavelength in the liquid. (The effect of the liquid may also be regarded as increasing the effective numerical aperture (NA) of the system and also increasing the depth of focus.) Other immersion liquids have been proposed, including water with solid particles (e.g. quartz) suspended therein, or a liquid with a nano-particle suspension (e.g. particles with a maximum dimension of up to 10 nm). The suspended particles may or may not have a similar or the same refractive index as the liquid in which they are suspended. Other liquids which may be suitable include a hydrocarbon, such as an aromatic, a fluorohydrocarbon, and/or an aqueous solution.

Submersing the substrate or substrate and substrate table in a bath of liquid (see, for example, U.S. Pat. No. 4,509,852) means that there is a large body of liquid that must be accelerated during a scanning exposure. This requires additional or more powerful motors and turbulence in the liquid may lead to undesirable and unpredictable effects.

In an immersion apparatus, immersion fluid is handled by a fluid handling system, device structure or apparatus. In an embodiment the fluid handling system may supply immersion fluid and therefore be a fluid supply system. In an embodiment the fluid handling system may at least partly confine immersion fluid and thereby be a fluid confinement system. In an embodiment the fluid handling system may provide a barrier to immersion fluid and thereby be a barrier member, such as a fluid confinement structure. In an embodiment the fluid handling system may create or use a flow of gas, for example to help in controlling the flow and/or the position of the immersion fluid. The flow of gas may form a seal to confine the immersion fluid so the fluid handling structure may be referred to as a seal member; such a seal member may be a fluid confinement structure. In an embodiment, immersion liquid is used as the immersion fluid. In that case the fluid handling system may be a liquid handling system. In reference to the aforementioned description, reference in this paragraph to a feature defined with respect to fluid may be understood to include a feature defined with respect to liquid.

One of the arrangements proposed is for a liquid supply system to provide liquid on only a localized area of the substrate and in between the final element of the projection system and the substrate using a liquid confinement system (the substrate generally has a larger surface area than the final element of the projection system). One way which has been proposed to arrange for this is disclosed in PCT patent application publication no. WO 99/49504. As illustrated in FIGS. 2 and 3, liquid is supplied by at least one inlet onto the substrate, desirably along the direction of movement of the substrate relative to the final element, and is removed by at least one outlet after having passed under the projection system. That is, as the substrate is scanned beneath the element in a −X direction, liquid is supplied at the +X side of the element and taken up at the −X side. FIG. 2 shows the arrangement schematically in which liquid is supplied via inlet and is taken up on the other side of the element by outlet which is connected to a low pressure source. The arrows above the substrate W illustrate the direction of liquid flow, and the arrow below the substrate W illustrates the direction of movement of the substrate table. In the illustration of FIG. 2 the liquid is supplied along the direction of movement of the substrate relative to the final element, though this does not need to be the case. Various orientations and numbers of in- and out-lets positioned around the final element are possible, one example is illustrated in FIG. 3 in which four sets of an inlet with an outlet on either side are provided in a regular pattern around the final element. Arrows in liquid supply and liquid recovery devices indicate the direction of liquid flow.

A further immersion lithography solution with a localized liquid supply system is shown in FIG. 4. Liquid is supplied by two groove inlets on either side of the projection system PS and is removed by a plurality of discrete outlets arranged radially outwardly of the inlets. The inlets and outlets can be arranged in a plate with a hole in its center and through which the projection beam is projected. Liquid is supplied by one groove inlet on one side of the projection system PS and removed by a plurality of discrete outlets on the other side of the projection system PS, causing a flow of a thin film of liquid between the projection system PS and the substrate W. The choice of which combination of inlet and outlets to use can depend on the direction of movement of the substrate W (the other combination of inlet and outlets being inactive). In the cross-sectional view of FIG. 4, arrows illustrate the direction of liquid flow in inlets and out of outlets.

In European patent application publication no. EP 1420300 and United States patent application publication no. US 2004-0136494, each hereby incorporated in their entirety by reference, the idea of a twin or dual stage immersion lithography apparatus is disclosed. Such an apparatus is provided with two tables for supporting a substrate. Leveling measurements are carried out with a table at a first position, without immersion liquid, and exposure is carried out with a table at a second position, where immersion liquid is present. Alternatively, the apparatus has only one table.

PCT patent application publication WO 2005/064405 discloses an all wet arrangement in which the immersion liquid is unconfined. In such a system the whole top surface of the substrate is covered in liquid. This may be advantageous because then the whole top surface of the substrate is exposed to the substantially same conditions. This has an advantage for temperature control and processing of the substrate. In WO 2005/064405, a liquid supply system provides liquid to the gap between the final element of the projection system and the substrate. That liquid is allowed to leak (or flow) over the remainder of the substrate. A barrier at the edge of a substrate table prevents the liquid from escaping so that it can be removed from the top surface of the substrate table in a controlled way. Although such a system improves temperature control and processing of the substrate, evaporation of the immersion liquid may still occur. One way of helping to alleviate that problem is described in United States patent application publication no. US 2006/0119809. A member is provided which covers the substrate in all positions and which is arranged to have immersion liquid extending between it and the top surface of the substrate and/or substrate table which holds the substrate.

### SUMMARY

In immersion lithography, temperature variations in the immersion liquid can result in imaging defects because of the high sensitivity of refractive index of the immersion liquid to the temperature of immersion liquid.

It is desirable, for example, to reduce or eliminate temperature variations in immersion liquid being supplied to a lithographic apparatus.

According to an aspect, there is provided a fluid supply system for a lithographic apparatus, comprising: a first controller configured to vary a fluid flow rate to a first component from a fluid source while maintaining total flow resistance to fluid flow downstream of the fluid source substantially constant.

According to an aspect, there is provided a method of varying the fluid flow rate to a component from a fluid source, the method comprising adjusting a valve in a first fluid flow path between the fluid source and the first component whilst maintaining the total flow resistance to fluid flow downstream of the fluid source substantially constant.

According to an aspect, there is provided a fluid supply system for a lithographic apparatus comprising a first fluid path defined by a first fluid flow conduit connecting a fluid source to a first component, the system comprising: a junction in the first fluid flow conduit connecting the first fluid flow conduit to a drain component via a first drain fluid flow path; and a first controller configured to varying a fluid rate to the first component, the controller configured to: vary the fluid rate in the first fluid flow conduit between the junction and the first component, vary the fluid rate in the first drain fluid flow path between the junction and the drain component, and maintain a substantially constant pressure in the fluid flow at the junction.

According to an aspect, there is provided a method of varying the fluid flow rate to a component from a fluid source, the method comprising adjusting a valve in a fluid flow path between the fluid source and the component while maintaining total flow resistance to fluid flow downstream of the fluid source substantially constant.

According to an aspect, there is provided a method of varying the fluid flow rate to a component from a fluid source, the method comprising: varying the fluid rate in a fluid flow conduit between a junction, at which the fluid flow conduit is connected to a drain component via a drain fluid flow path, and the component; varying the fluid flow rate in the drain fluid flow path between the junction and the drain component; and maintaining a substantially constant pressure in the fluid flow at the junction.

According to an aspect, there is provided a fluid supply system for a lithographic apparatus comprising a first fluid path defined by a first fluid flow conduit connecting a fluid source to a first component, the system comprising: a junction in the first fluid flow conduit connecting the first fluid flow conduit to a second component via a second fluid flow path; and a controller configured to vary the fluid rate to the first component, the controller configured to: vary the fluid rate in the first fluid flow conduit between the junction and the first component, vary the fluid rate in the second fluid flow path between the junction and the second component, and maintain a substantially constant pressure in the fluid flow at the junction.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIG. 1 depicts a lithographic apparatus according to an embodiment of the invention;

FIGS. 2 and 3 depict a liquid supply system for use in a lithographic projection apparatus;

FIG. 4 depicts a further liquid supply system for use in a lithographic projection apparatus;

FIG. 5 depicts a further liquid supply system for use in a lithographic projection apparatus;

FIG. 6 illustrates schematically a fluid supply system of an embodiment of the present invention;

FIG. 7 illustrates schematically a fluid supply system of a further embodiment of the present invention;

FIG. 8 illustrates schematically a fluid supply system of a further embodiment of the present invention;

FIG. 9 illustrates schematically a fluid supply system of a further embodiment of the present invention;

FIG. 10 illustrates schematically a fluid supply system of a further embodiment of the present invention;

FIG. 11 illustrates schematically a fluid supply system of a further embodiment of the present invention; and

FIG. 12 illustrates schematically a fluid supply system of a further embodiment of the present invention.

### DETAILED DESCRIPTION

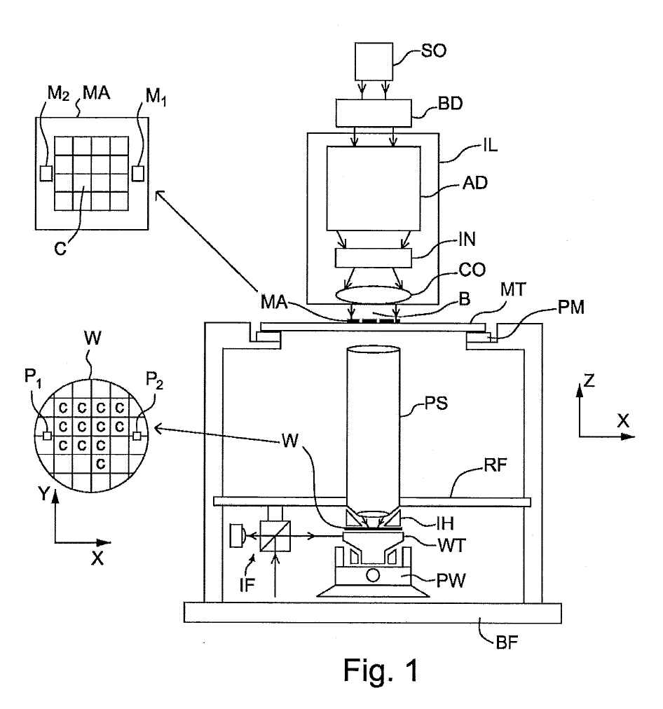

FIG. 1 schematically depicts a lithographic apparatus according to one embodiment of the invention. The apparatus comprises:

an illumination system (illuminator) IL configured to condition a radiation beam B (e.g. UV radiation or DUV radiation);

a support structure (e.g. a mask table) MT constructed to support a patterning device (e.g. a mask) MA and connected to a first positioner PM configured to accurately position the patterning device MA in accordance with certain parameters;

a substrate table (e.g. a wafer table) WT constructed to hold a substrate (e.g. a resist-coated wafer) W and connected to a second positioner PW configured to accurately position the substrate W in accordance with certain parameters; and

a projection system (e.g. a refractive projection lens system) PS configured to project a pattern imparted to the radiation beam B by patterning device MA onto a target portion C (e.g. comprising one or more dies) of the substrate W.

The illumination system IL may include various types of optical components, such as refractive, reflective, magnetic, electromagnetic, electrostatic or other types of optical components, or any combination thereof, for directing, shaping, or controlling radiation.

The support structure MT holds the patterning device MA. It holds the patterning device MA in a manner that depends on the orientation of the patterning device MA, the design of the lithographic apparatus, and other conditions, such as for example whether or not the patterning device MA is held in a vacuum environment. The support structure MT can use mechanical, vacuum, electrostatic or other clamping techniques to hold the patterning device MA. The support structure MT may be a frame or a table, for example, which may be fixed or movable as required. The support structure MT may ensure that the patterning device MA is at a desired position, for example with respect to the projection system PS. Any use of the terms “reticle” or “mask” herein may be considered synonymous with the more general term “patterning device.”

The term “patterning device” used herein should be broadly interpreted as referring to any device that can be used to impart a radiation beam with a pattern in its cross-section such as to create a pattern in a target portion of the substrate. It should be noted that the pattern imparted to the radiation beam may not exactly correspond to the desired pattern in the target portion of the substrate, for example if the pattern includes phase-shifting features or so called assist features. Generally, the pattern imparted to the radiation beam will correspond to a particular functional layer in a device being created in the target portion, such as an integrated circuit.

The patterning device MA may be transmissive or reflective. Examples of patterning devices include masks, programmable mirror arrays, and programmable LCD panels. Masks are well known in lithography, and include mask types such as binary, alternating phase-shift, and attenuated phase-shift, as well as various hybrid mask types. An example of a programmable mirror array employs a matrix arrangement of small mirrors, each of which can be individually tilted so as to reflect an incoming radiation beam in different directions. The tilted mirrors impart a pattern in a radiation beam which is reflected by the mirror matrix.

The term “projection system” used herein should be broadly interpreted as encompassing any type of projection system, including refractive, reflective, catadioptric, magnetic, electromagnetic and electrostatic optical systems, or any combination thereof, as appropriate for the exposure radiation being used, or for other factors such as the use of an immersion liquid or the use of a vacuum. Any use of the term “projection lens” herein may be considered as synonymous with the more general term “projection system”.

As here depicted, the apparatus is of a transmissive type (e.g. employing a transmissive mask). Alternatively, the apparatus may be of a reflective type (e.g. employing a programmable mirror array of a type as referred to above, or employing a reflective mask).

The lithographic apparatus may be of a type having two (dual stage) or more substrate tables (and/or two or more patterning device tables). In such “multiple stage” machines the additional tables may be used in parallel, or preparatory steps may be carried out on one or more tables while one or more other tables are being used for exposure.

Referring to FIG. 1, the illuminator IL receives a radiation beam from a radiation source SO. The source SO and the lithographic apparatus may be separate entities, for example when the source SO is an excimer laser. In such cases, the source SO is not considered to form part of the lithographic apparatus and the radiation beam is passed from the source SO to the illuminator IL with the aid of a beam delivery system BD comprising, for example, suitable directing mirrors and/or a beam expander. In other cases the source SO may be an integral part of the lithographic apparatus, for example when the source SO is a mercury lamp. The source SO and the illuminator IL, together with the beam delivery system BD if required, may be referred to as a radiation system.

The illuminator IL may comprise an adjuster AD for adjusting the angular intensity distribution of the radiation beam. Generally, at least the outer and/or inner radial extent (commonly referred to as σ-outer and σ-inner, respectively) of the intensity distribution in a pupil plane of the illuminator IL can be adjusted. In addition, the illuminator IL may comprise various other components, such as an integrator IN and a condenser CO. The illuminator IL may be used to condition the radiation beam, to have a desired uniformity and intensity distribution in its cross-section. Similar to the source SO, the illuminator IL may or may not be considered to form part of the lithographic apparatus. For example, the illuminator IL may be an integral part of the lithographic apparatus or may be a separate entity from the lithographic apparatus. In the latter case, the lithographic apparatus may be configured to allow the illuminator IL to be mounted thereon. Optionally, the illuminator IL is detachable and may be separately provided (for example, by the lithographic apparatus manufacturer or another supplier).

The radiation beam B is incident on the patterning device (e.g., mask) MA, which is held on the support structure (e.g., mask table) MT, and is patterned by the patterning device MA. Having traversed the patterning device MA, the radiation beam B passes through the projection system PS, which focuses the beam onto a target portion C of the substrate W. With the aid of the second positioner PW and position sensor IF (e.g. an interferometric device, linear encoder or capacitive sensor), the substrate table WT can be moved accurately, e.g. so as to position different target portions C in the path of the radiation beam B. Similarly, the first positioner PM and another position sensor (which is not explicitly depicted in FIG. 1) can be used to accurately position the patterning device MA with respect to the path of the radiation beam B, e.g. after mechanical retrieval from a mask library, or during a scan. In general, movement of the support structure MT may be realized with the aid of a long-stroke module (coarse positioning) and a short-stroke module (fine positioning), which form part of the first positioner PM. Similarly, movement of the substrate table WT may be realized using a long-stroke module and a short-stroke module, which form part of the second positioner PW. In the case of a stepper (as opposed to a scanner) the support structure MT may be connected to a short-stroke actuator only, or may be fixed. Patterning device MA and substrate W may be aligned using patterning device alignment marks M1, M2 and substrate alignment marks P1, P2. Although the substrate alignment marks as illustrated occupy dedicated target portions, they may be located in spaces between target portions C (these are known as scribe-lane alignment marks). Similarly, in situations in which more than one die is provided on the patterning device MA, the patterning device alignment marks may be located between the dies.

The depicted apparatus could be used in at least one of the following modes:

1. In step mode, the support structure MT and the substrate table WT are kept essentially stationary, while an entire pattern imparted to the radiation beam B is projected onto a target portion C at one time (i.e. a single static exposure). The substrate table WT is then shifted in the X and/or Y direction so that a different target portion C can be exposed. In step mode, the maximum size of the exposure field limits the size of the target portion C imaged in a single static exposure.

2. In scan mode, the support structure MT and the substrate table WT are scanned synchronously while a pattern imparted to the radiation beam B is projected onto a target portion C (i.e. a single dynamic exposure). The velocity and direction of the substrate table WT relative to the support structure MT may be determined by the (de-)magnification and image reversal characteristics of the projection system PS. In scan mode, the maximum size of the exposure field limits the width (in the non-scanning direction) of the target portion C in a single dynamic exposure, whereas the length of the scanning motion determines the height (in the scanning direction) of the target portion C.

3. In another mode, the support structure MT is kept essentially stationary holding a programmable patterning device, and the substrate table WT is moved or scanned while a pattern imparted to the radiation beam is projected onto a target portion C. In this mode, generally a pulsed radiation source is employed and the programmable patterning device is updated as required after each movement of the substrate table WT or in between successive radiation pulses during a scan. This mode of operation can be readily applied to maskless lithography that utilizes programmable patterning device, such as a programmable mirror array of a type as referred to above.

Combinations and/or variations on the above described modes of use or entirely different modes of use may also be employed.

Arrangements for providing liquid between a final element of the projection system and the substrate can be classed into at least two general categories. These are the bath type (or submersed) arrangement and the localized immersion system. In the submersed arrangement, substantially the whole of the substrate and optionally part of the substrate table is submersed in a liquid, such as in a bath or under a film of liquid. The localized immersion system uses a liquid supply system to provide liquid to only a localized area of the substrate. In the latter category, the space filled by liquid is smaller in plan than the top surface of the substrate. The volume of liquid in the space that covers the substrate remains substantially stationary relative to the projection system while the substrate moves underneath that space.

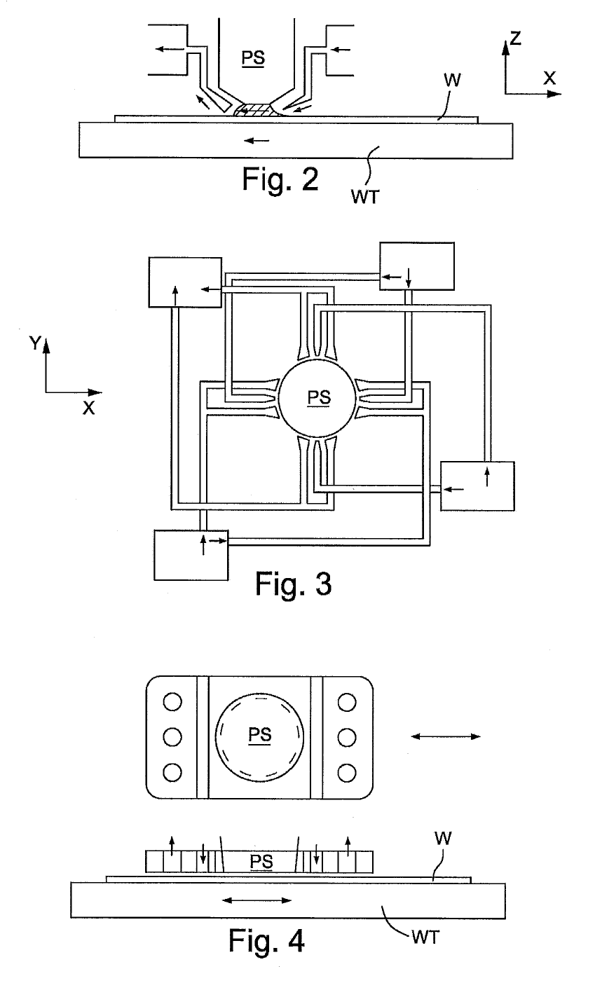

A further arrangement, to which an embodiment of the present invention may be directed, is an all wet arrangement. In an all wet arrangement the liquid is unconfined. In this arrangement, substantially the whole top surface of the substrate and all or part of the substrate table is covered in immersion liquid. The depth of the liquid covering at least the substrate is small. The liquid may be a film, such as a thin film, of liquid on the substrate. Any of the liquid supply devices of FIGS. 2-5 may be used in such a system. However, sealing features are not present in the liquid supply device, are not activated, are not as efficient as normal or are otherwise ineffective to seal liquid to only the localized area. Four different types of localized liquid supply systems are illustrated in FIGS. 2-5. The liquid supply systems disclosed in FIGS. 2-4 were described above.

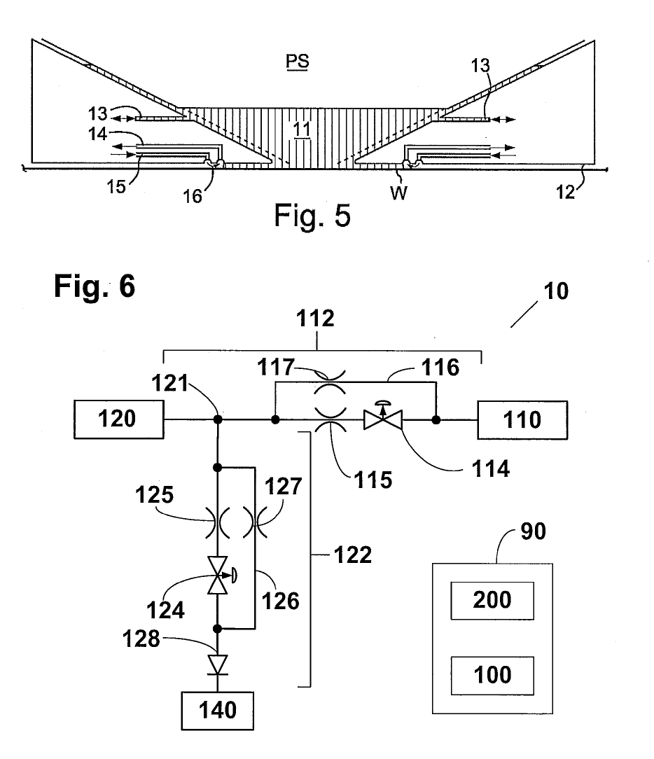

Another arrangement which has been proposed is to provide the liquid supply system with a fluid confinement structure. The fluid confinement structure may extend along at least a part of a boundary of the space between the final element of the projection system and the substrate table. Such an arrangement is illustrated in FIG. 5. The fluid confinement structure is substantially stationary relative to the projection system in the XY plane though there may be some relative movement in the Z direction (in the direction of the optical axis). A seal may be formed between the fluid confinement structure and the surface of the substrate. In an embodiment, a seal is formed between the fluid confinement structure and the surface of the substrate. Desirably the seal may be a contactless seal such as a gas seal. Such a system with a gas seal is disclosed in United States patent application publication no. US 2004-0207824 and illustrated in FIG. 5.

FIG. 5 schematically depicts a localized liquid supply system or fluid handling structure or device with a body 12 forming a barrier member or fluid confinement structure, which extends along at least a part of a boundary of the space 11 between the final element of the projection system PS and the substrate table WT or substrate W. (Please note that reference in the following text to surface of the substrate W also refers in addition or in the alternative to a surface of the substrate table WT, unless expressly stated otherwise.) The fluid handling structure is substantially stationary relative to the projection system PS in the XY plane though there may be some relative movement in the Z direction (in the direction of the optical axis). In an embodiment, a seal is formed between the body 12 and the surface of the substrate W and may be a contactless seal such as a gas seal or fluid seal.

The fluid handling device at least partly contains liquid in the space 11 between a final element of the projection system PS and the substrate W. A contactless seal, such as a gas seal 16, to the substrate W may be formed around the image field of the projection system PS so that liquid is confined within the space 11 between the substrate W surface and the final element of the projection system PS. The space 11 is at least partly formed by the body 12 positioned below and surrounding the final element of the projection system PS. Liquid is brought into the space 11 below the projection system PS and within the body 12 by liquid inlet 13. The liquid may be removed by liquid outlet 13. The body 12 may extend a little above the final element of the projection system PS. The liquid level rises above the final element so that a buffer of liquid is provided. In an embodiment, the body 12 has an inner periphery that at the upper end closely conforms to the shape of the projection system PS or the final element thereof and may, e.g., be round. At the bottom, the inner periphery closely conforms to the shape of the image field, e.g., rectangular, though this need not be the case.

The liquid is contained in the space 11 by the gas seal 16 which, during use, is formed between the bottom of the body 12 and the surface of the substrate W. The gas seal 16 is formed by gas, e.g. air or synthetic air but, in an embodiment, N₂ or another inert gas. The gas in the gas seal 16 is provided under pressure via inlet 15 to the gap between body 12 and substrate W. The gas is extracted via outlet 14. The overpressure on the gas inlet 15, vacuum level on the outlet 14 and geometry of the gap are arranged so that there is a high-velocity gas flow inwardly that confines the liquid. The force of the gas on the liquid between the body 12 and the substrate W contains the liquid in a space 11. The inlets/outlets may be annular grooves which surround the space 11. The annular grooves may be continuous or discontinuous. The flow of gas is effective to contain the liquid in the space 11. Such a system is disclosed in United States patent application publication no. US 2004-0207824.

The example of FIG. 5 is a so called localized area arrangement in which liquid is only provided to a localized area of the top surface of the substrate W at any one time. Other arrangements are possible, including fluid handling systems which make use of a single phase extractor or a two phase extractor as disclosed, for example, in United States patent application publication no US 2006-0038968. In an embodiment, a single or two phase extractor may comprise an inlet which is covered in a porous material. In an embodiment of a single phase extractor the porous material is used to separate liquid from gas to enable single-liquid phase liquid extraction. A chamber downstream of the porous material is maintained at a slight under pressure and is filled with liquid. The under pressure in the chamber is such that the meniscuses formed in the holes of the porous material prevent ambient gas from being drawn into the chamber. However, when the porous surface comes into contact with liquid there is no meniscus to restrict flow and the liquid can flow freely into the chamber. The porous material has a large number of small holes, e.g. of diameter in the range of 5 to 300 μm, desirably 5 to 50 μm. In an embodiment, the porous material is at least slightly liquidphilic (e.g., hydrophilic), i.e. having a contact angle of less than 90° to the immersion liquid, e.g. water.

Another arrangement which is possible is one which works on a gas drag principle. The so-called gas drag principle has been described, for example, in United States patent application publication no. US 2008-0212046 and United States patent application no. U.S. 61/071,621 filed on 8 May 2008. In that system the extraction holes are arranged in a shape which desirably has a corner. The corner may be aligned with the stepping or scanning directions. This reduces the force on the meniscus between two openings in the surface of the fluid handing structure for a given speed in the step or scan direction compared to if the two outlets were aligned perpendicular to the direction of scan. An embodiment of the invention may be applied to a fluid handling structure used in all wet immersion apparatus. In the all wet embodiment, fluid is allowed to cover the whole of the top surface of the substrate table, for example, by allowing liquid to leak out of a confinement structure which confines liquid to between the final element of projection system and the substrate. An example of a fluid handling structure for an all wet embodiment can be found in United States patent application no. U.S. 61/136,380 filed on 2 Sep. 2008.

In an immersion lithography apparatus, fluid is typically supplied to the fluid handling system. If the fluid supplied is the fluid for the immersion space (that is the immersion fluid) it is desirable to control the temperature of that fluid carefully, especially if it is liquid or another substantially incompressible fluid for the immersion space. For example, the temperature accuracy may be of the order of less than 50 mK. This is because of the high sensitivity of the refractive index of the immersion liquid to liquid temperature. A difference in temperature may cause a change in refractive index which may cause an imaging defect.

Some operations in an immersion lithographic apparatus may require a change in flow rate of immersion liquid. Such a change of flow may be a change between static flow rates. A static flow rate is a flow rate which is substantially constant over a period of time. For example, such a change may occur when a shutter member, such as a dummy substrate (or closing disk), is placed under the liquid handling system during, e.g., substrate swap. The presence of a shutter member under the liquid handling structure maintains liquid in the immersion space 11. Keeping liquid in the immersion space avoids having to empty and refill the immersion space which could cause drying stains on a drying surface of the immersion space (including the projection system) or temperature fluctuations as a consequence of droplets evaporating from the surface of the immersion space. However, for example, during substrate swap a reduced rate of immersion liquid flow may be desired. The flow rate of supplied liquid during exposure may have a substantially constant flow rate; the flow rate of supplied liquid during, e.g., substrate swap may be at a different, e.g. substantially constant, flow rate.

Another type of shutter member is, for example, a bridge which extends between two tables during, e.g., substrate swap such as a first substrate table carrying a first substrate and a second substrate carrying a second substrate. When the first substrate is swapped for the second substrate under the projection system, the liquid handling system is maintained full. The first substrate table is moved from under the projection system so that the bridge passes under the projection system followed by the second substrate table. In this way a surface always opposes the bottom of the liquid handling system, so that the surface defines in part the space in which liquid is confined. There may be gaps or grooves in the joint between the substrate tables and the bridge. To reduce the risk of liquid leaking from the liquid handling system, or of bubbles being generated in the liquid in the liquid handling system, the flow rate of liquid supplied to the immersion space may be reduced. Another example of where a varying liquid flow rate may be desired is one or more cooling channels in a substrate table.

Changing the flow of immersion liquid may be achieved by varying the flow rate out of a liquid source or by switching a single valve in a bypass branch in the liquid flow path between the liquid source and the component to which the liquid is being provided. Both of these control methods have one or more disadvantages. It can take an undesirably long time to reach a stable flow after the liquid source changes its outlet pressure to reach the new desired flow rate. The time it takes for a stable flow to be achieved may be determined by the response of the flow controller to a change of its outlet pressure. Both methods result in either a changed total flow rate from the liquid source or a different pressure loss over the liquid source. Both of these outcomes are undesirable because they each can result in a change in temperature of the liquid being supplied. It is desirable that the flow rate of liquid out of the liquid source is substantially constant and/or that the pressure of liquid at an outlet to the liquid source is substantially constant. This substantially eliminates the above mentioned source of temperature variation.

FIG. 6 illustrates a liquid supply system 10 according to an embodiment of the present invention. The liquid supply system 10 is under the control of a liquid controller 90 comprising a first controller 100 and a second controller 200. The liquid controller 90 is used to vary the liquid flow rate to a first component 110 from a liquid source 120.

The first controller 100 is arranged to vary the liquid flow rate to the first component 110 while maintaining the total flow resistance to liquid flow substantially constant downstream of the liquid source 120. In an embodiment the first controller 100 is arranged to vary the liquid flow rate to the first component 110 while maintaining a substantially constant pressure at an outlet of the liquid source 120.

The second controller 200 is arranged to control the liquid source 120. The second controller 200 helps ensure that the liquid source 120 supplies liquid at a substantially constant pressure or at a substantially constant flow rate or both.

The liquid supply system 10 comprises a first liquid flow path 112 defined by a conduit between the liquid source 120 and the first component 110. A first component valve 114 is provided in the first liquid flow path 112. The valve 114 is desirably controlled by the first controller 100 to change between an open and a closed position.

A first by-pass line 116 defined by a conduit is provided which connects the first liquid flow path 112 upstream of the first valve 114 to the first liquid flow path downstream of the valve 114. That is, the by-pass line 116 provides a path for liquid which by-passes the valve 114.

If the valve 114 is closed, liquid will only reach the first component 110 through the by-pass line 116 from the liquid source 120. If the valve 114 is fully open, liquid will reach the first component 110 through the valve 114 as well as through the first by-pass line 116. The flow rate to the first component 110 can be varied between these two extremes by moving the valve 114 between the open and closed positions.

Flow restriction 115 is illustrated in the first liquid flow path 112 in the part of the liquid flow path upstream of the valve 114, parallel to the by-pass line 116. Flow restriction 117 is shown in the liquid flow path 112 in the by-pass line 116. These flow restrictions may either be deliberately defined or may simply be as a result of the configuration and dimensions of the conduit used to define the first liquid flow path 112.

In order to enable the liquid supply system to maintain the total flow resistance to liquid flow downstream of the liquid source 120 substantially constant, an additional liquid flow path is defined, for example to a drain 140. A first drain liquid flow path 122 is defined by a conduit. The first drain liquid flow path 122 connects the liquid source 120, e.g. at a liquid source outlet, and a drain 140. In an embodiment the first drain liquid flow path 122, starts at a junction 121 with the first liquid flow path 112. It may be regarded that the first liquid flow path 112 and first drain liquid flow path 122 have a common flow path between the liquid source 120 and the junction 121. The first controller 100 is configured to vary the flow rate between the junction 121 and the first component 110 while maintaining a substantially constant pressure in the liquid flow at the junction 121 (and indeed at any point between the junction 121 and the liquid source 120).

In an embodiment the drain 140 may be a component to which liquid must be provided at a certain flow rate. However, that embodiment may only be feasible if the rate of liquid flow rate needed at the drain is proportional to the rate of liquid desired at the first component 110. In another embodiment the drain 140 is either a position at which liquid can be re-cycled back to the liquid source 120 (for example directly or through a filter or other conditioning apparatus) or a position at which the liquid may be disposed of.

A first drain valve 124 is provided in the first drain liquid flow path 122. A flow restriction 125 is illustrated in the first drain liquid flow path 122. A by-pass line 126 may define a flow path parallel to the first drain valve 124 and the flow restriction 125. A flow restriction 127 may be in the by-pass line 126. As with the flow restrictions 115, 117, the flow restrictions 125, 127 in the first drain liquid flow path 122 may be a flow restriction deliberately defined in the first drain liquid flow path 122. The flow restrictions 125, 127 may simply be a result of the configuration and dimensions of the conduits which define the first drain liquid flow path 122.

In order to maintain the flow resistance to liquid downstream of the liquid source 120 substantially constant the following steps are performed. When the valve 114 is opened, thereby resulting in decreased flow resistance in the first liquid flow path 112, the first drain valve 124 is closed accordingly to increase the flow resistance for liquid through the first drain liquid flow path 122. Thereby the flow of liquid into the drain 140 is decreased and the flow of liquid to the first component 110 is increased. At the same time the total flow resistance to liquid downstream of the liquid source 120 is maintained substantially constant. Thereby the liquid flow rate to the first component 110 may be varied without changing the flow rate through or pressure loss over the liquid source 120. As a result, a stable liquid supply rate may be quickly achieved. The liquid supplied by the liquid source 120 is received by a consumer, for example at the first component 110, at a substantially consistent temperature, for example, when the flow rate of the liquid supplied to the consumer is varied, e.g. changed.

In order to decrease the rate of liquid flow to the first component 110, the first controller 100 operates. The first controller may operate to close the valve 114 and open the first drain valve 124. Accordingly the total flow resistance to liquid downstream of the liquid source 120 may be maintained to be substantially constant.

It may be necessary to carefully balance the various flow restrictions 115, 117, 125, 127 in the first liquid flow path 112 and the first drain liquid flow path 122. This may help ensure that by opening one valve and closing another valve the total flow resistance is maintained substantially constant. In an embodiment the valves are operated simultaneously, for example so that one may open and the other is closed.

A one way valve 128 is illustrated in the first drain liquid flow path 122. This protects the liquid source 120 from back pressures in the drain 140. An over pressured drain 140 might lead to damage and/or contamination of the liquid source 120.

In the embodiment of FIG. 6, the first drain liquid flow path 122 comprises the first drain by-pass line 126 defined by a conduit or conduits which connects the first drain liquid flow path 122 upstream of the first drain valve 124 to the first drain liquid flow path 122 downstream of the first drain valve 124. A flow restriction 127 is also illustrated in the first drain by-pass line 126. The by-pass line 126 helps ensure that there is always a flow of liquid through the first drain liquid flow path 122. This can hinder the growth of bacteria which might otherwise lead to difficulties such as filter blocking, imaging defects etc.

In some instances, there may be pressure fluctuations transmitted from the first component 110. For example the pressure of liquid at the first component 110 may change where the first component 110 is comprised in a liquid handling structure passing over a gap between the substrate table. The pressure applied to the liquid in the first component 110 may be different when the liquid handing structure is over the gap than compared to the pressure when the first component 110 is over the substrate table or substrate. Such a pressure fluctuation may be transmitted from the first component 110 through the liquid in the liquid supply system 10. The flow restriction 115 helps prevent the transmission of the pressure fluctuations further upstream in the liquid supply system 10.

If there are no pressure fluctuations in the system, the flow restriction 115 in the main part of the first liquid flow path 122 upstream of the valve 114 may be omitted. The flow rate to the first component 110 can be increased to a maximum supply liquid rate, when the valve 114 is open. However, it is desirable to have a certain amount of counter pressure in the liquid supply system 10 so the presence of the flow restriction 115 may be desirable.

Because the total flow resistance to liquid flow downstream of the liquid supply 120 is substantially constant, the time required for the second controller 200 to vary the rate of liquid supplied by the liquid source 120 no longer plays any role.

The magnitude of the flow restriction 117 in the by-pass line 116 and of the flow restriction 127 in the by-pass line 126 is not important in terms of maintaining the total flow resistance constant. It is possible to balance the flow restrictions of the flow restriction 115 and the valve 114 to the flow restrictions of the flow restriction 125 and the first drain valve 124. In order to do this, the flow restrictions 115, 125 may be adjusted or designed accordingly.

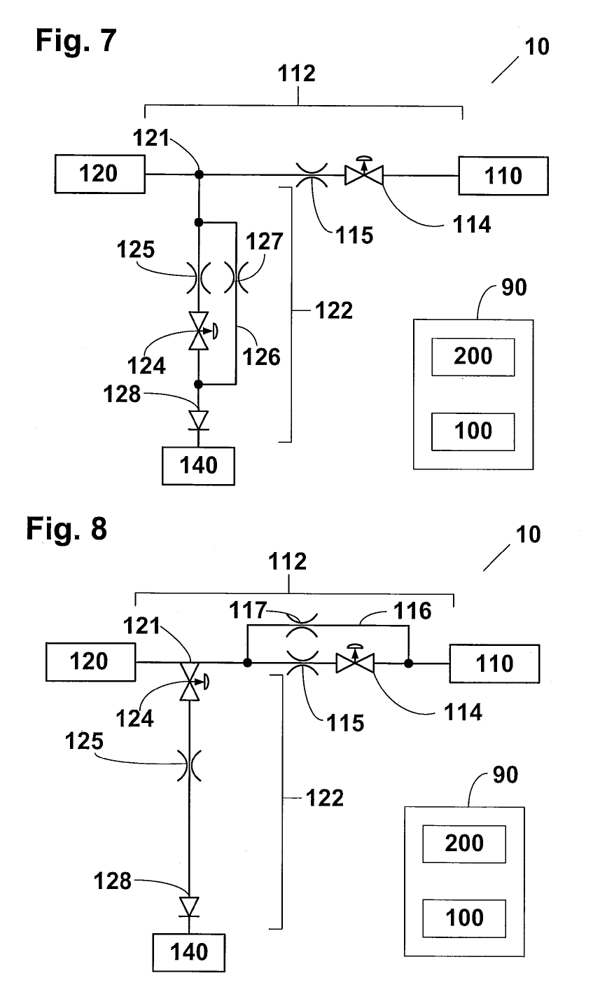

A further embodiment is illustrated in FIG. 7. The embodiment of FIG. 7 is the same as that of FIG. 6 except as described below. In the FIG. 7 embodiment, the by-pass line 116 is omitted. In this embodiment it is possible to achieve zero flow rate to the first component 110 by closing, the valve 114. The embodiment could improve throughput by enabling the reduction of pressure downstream i.e. at the consumer such as the first component 110. Therefore, an arrangement which omits the by-pass line 116 may approach zero flow faster than an arrangement with the by-pass line 116.

FIG. 8 illustrates a further embodiment. The embodiment of FIG. 8 is the same as the embodiment of FIG. 6 except as described below. In the embodiment of FIG. 8 the by-pass line 126 is omitted. By completely stopping the flow to drain 140, the flow that would have passed through the by-pass line 126 to the drain 140 may be, directed to the consumer, e.g. the first component 110. The maximum flow rate which may be supplied to the consumer may be larger than if the first drain flow path 122 to the drain included by-pass line 126.

In an embodiment the first drain valve 124 is a T valve and by-pass line 126 is omitted, as illustrated in FIG. 8. The T valve is integrated into the first liquid flow path 112 at the junction 121 so that the interconnecting volume between the T connection and the valve is small or substantially non existent. Liquid is prevented from standing still in the first drain liquid flow path 122 upstream of the first drain valve 124 when the first drain valve 124 is closed. In this embodiment the flow restriction 125 may be downstream of the first drain valve 124. An advantage of this arrangement is that compared to the embodiment with the by-pass line 126, the amount of liquid provided by the liquid source 120 is reduced. Advantageously the volume between the valve 124 and the junction 121 is minimized. The arrangement has fewer components than previously mentioned components, reducing the complexity of the system and facilitating repair.

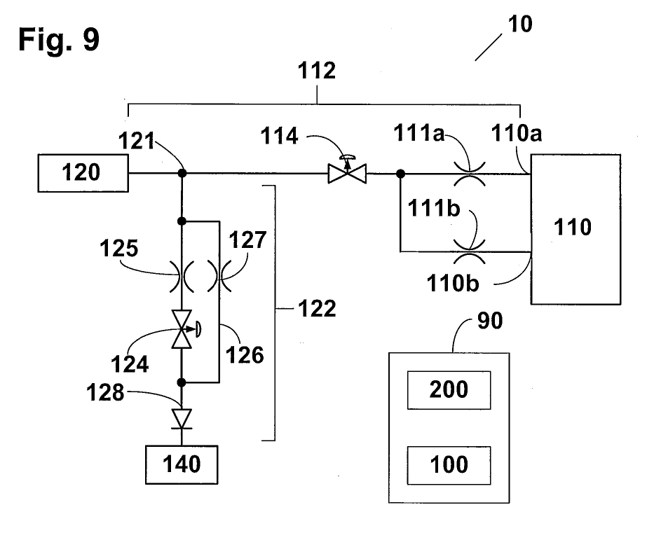

FIG. 9 illustrates a further embodiment. The embodiment of FIG. 9 is an embodiment having the features of FIG. 6 without the by-pass line 116. Desirably a flow restriction 115 is not provided in the first liquid flow path 112 upstream of the valve 114. Downstream of the valve 114 the first liquid flow path 112 is connected to a first component 110. In an embodiment the first liquid flow path 112 bifurcates after the valve 114 so that the first component 110 is provided with liquid at two ports 110a, 110b. A flow restriction 111a, 111b is provided upstream of each of the ports 110a, 110b. In an embodiment, the flow path 112 separates into more than two paths, so that there is a port 110 and a flow restriction 111 corresponding to each separate path.

The embodiment is particularly suitable for providing liquid to a liquid handling system, in particular to the part of the liquid handling system which provides, in use, liquid to the immersion space 11 through inlet 13 as shown in FIG. 5 and liquid in a direction towards the substrate, in use. In an arrangement as shown in FIG. 5, each port 110a, 110b may correspond to a supply of liquid to a different location of the liquid handling system, for example inlet 13 and to an inlet facing a surface of a substrate. In an embodiment, the different ports 110a, 110b may correspond to two different inlets for the same supply of liquid, for example two inlets 13 to the immersion space 11 or two inlets defined in the undersurface of a liquid handling structure.

An arrangement supplying liquid towards the substrate is not illustrated in FIG. 5, but is a modification of such a liquid handling system. The liquid handling system of U.S. patent application publication no. 2008/0212046 does have such a liquid supply. Such a supply is useful for avoiding formation of bubbles when the liquid supply passes over a gap, for example between the edge of the substrate and the substrate table. The ports 110a, 110b may be openings defined in the undersurface of the liquid handling structure 12. The ports may be sized to function as liquid flow restrictors, so the restrictions 111a, 111b may be the openings that define the ports 110a, 110b or be located adjacent to the ports in the liquid flow path.

In an embodiment the ports 110a, 110b are each an opening defined in the undersurface of the liquid handling structure 12. The ports may be positioned at locations to supply an even supply pressure of immersion liquid around the periphery of the undersurface. This facilitates the reduction, if not the avoidance, of the formation of bubbles. In an embodiment there are two inlets corresponding to two ports 110 spaced equidistantly from each other in the liquid handling system 12 at the same radial distance from the optical path. With an uneven distribution of inlets in the liquid handling system (for example one inlet), there may be an undesirable uneven pressure distribution over the undersurface of the liquid handling system. An embodiment of the present invention helps in providing an even pressure over the undersurface of the liquid supplied underneath the liquid handling structure.

In operating the liquid supply system to control the supply of liquid from the ports 110a, 110b, the valve 114 is closed. At the same time the drain valve 124 is opened. The flow rate of liquid supplied through the ports 110a, 110b is reduced (perhaps to zero). The flow restrictions in the liquid supply system, for example restrictions 125, 111a and 111b, may be selected to reduce the flow rate quickly. The original flow rate may be achieved by closing the drain valve 124 and opening the valve 114 at the same time.

The flow rate may be reduced when a shutter member is under the liquid handling structure during, e.g., substrate swap. For example, a bridge may be moving under the projection system PS, or a closing disk may be held by the liquid handling structure. The flow rate may be returned to its original level when recommencing exposure after, e.g., substrate swap. Reducing the flow rate to the ports 110a, 110b may reduce the risk of creating bubbles and alter the flight height (the distance between the lowest part of the undersurface of the liquid handling structure and an opposing surface).

In the embodiment of FIG. 9, the liquid flow rate to the first component 110 may be zero when the valve 114 is fully closed. This may be desirable when the shutter member closes the immersion space defined in the liquid handling structure, such as when using a closing disc. In an embodiment a by-pass line 116 like in the FIG. 6 embodiment may be present. Liquid thus may be continually supplied through the ports 110a, 110b. This may be desirable when crossing a bridge as the risk of losing liquid from the immersion space may be reduced.

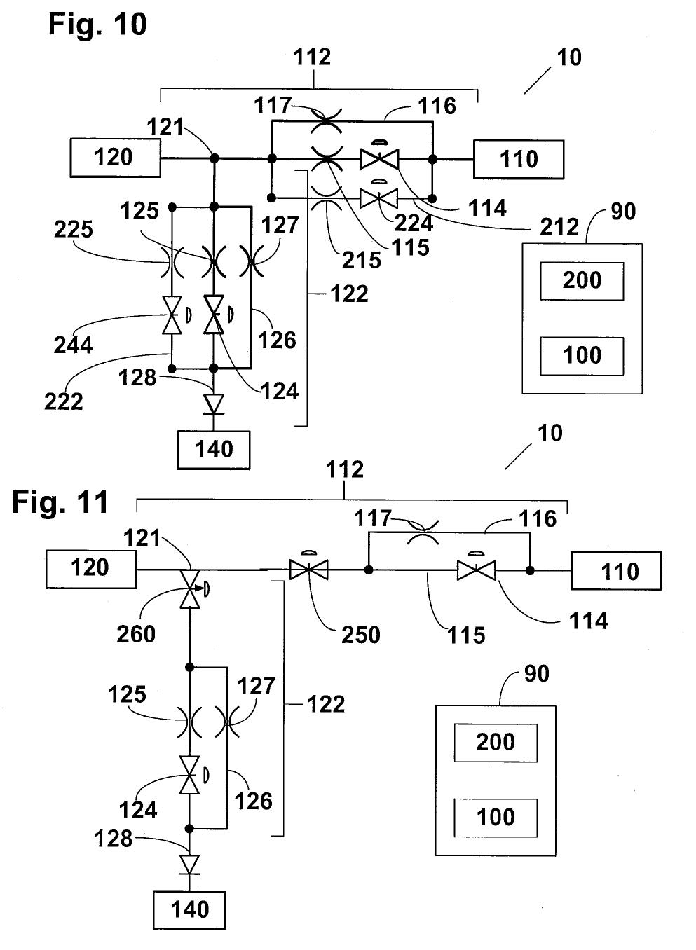

FIG. 10 illustrates a further embodiment. The embodiment of FIG. 10 is the same as that of FIG. 6 except as described below.

The embodiment of FIG. 6 only allows two different flow rates to the first component 110. In contrast, the embodiment of FIG. 10 allows four different flow rates to be achieved by the addition of two further valves. That is, a further liquid flow path 212 with component valve 224 is provided between the liquid source 120 and the first component 110. An associated flow restriction 215 may be provided. A further drain liquid flow path 222 with a drain valve 244 and flow restriction 225 is provided so that any change in flow resistance of the further liquid flow path 212 can be compensated for by changing the flow resistance of the further drain liquid flow path 222. This is achieved under the control of the first controller 100 by controlling the valves 224, 244 in opposite ways in the same way that the valve 114 and drain valve 124 are operated. The flow resistance of the further liquid flow path 212 may be different to that of the flow path in which the valve 114 is situated. Thus, the embodiment of FIG. 10 allows four different flow rates to the first component 110. In a first flow rate both valves 114, 124 are open, in a second flow rate only valve 114 is open, in a third flow rate only valve 224 is open and in the fourth flow rate neither valve 114 nor valve 224 is open.

FIG. 11 illustrates a further embodiment. The embodiment of FIG. 11 is the same as that of FIG. 6 except as described below.

Like the embodiment of FIG. 8, the embodiment of FIG. 11 allows more than two flow rates to the consumer 110. Additional to the two flow rates of FIG. 6, the embodiment of FIG. 11 can also reduce the flow rate to zero. The first liquid flow path 112 is provided with an inline valve 250 up stream of the by-pass line 116. The first drain liquid flow path 122 is provided with a corresponding valve 260. Valve 260 is desirably provided as a T valve as described above in relation to an embodiment of FIG. 8 so that there is substantially zero volume of static liquid.

In order to reduce the flow to the first component 110 to zero the valve 250 is closed and the valves 124 and 260 are opened. To achieve intermediate and high flow rate to the first component 110, valve 250 is opened. To achieve high flow rates valve 114 is open. At high flow rate valve 260 is closed. For intermediate flow rate, valve 114 is closed so that all of the liquid supplied to the first component 110 passes through by-pass line 116. In this arrangement valve 124 is closed and valve 260 is open so that flow to the drain 140 is only through the by-pass line 126. In an embodiment valves 124 and 250 are operated simultaneously so that valve 124 opens as valve 250 is closed. The valves 124 and 250 may both be connected to and operable by a controller which may be connected to or be part of the liquid controller 90. Valves 114 and 260 are operated simultaneously so that valve 114 opens as valve 260 is closed. The valves 114 and 260 may both be connected to and operable by a controller which may be connected to or be part of the liquid controller 90.

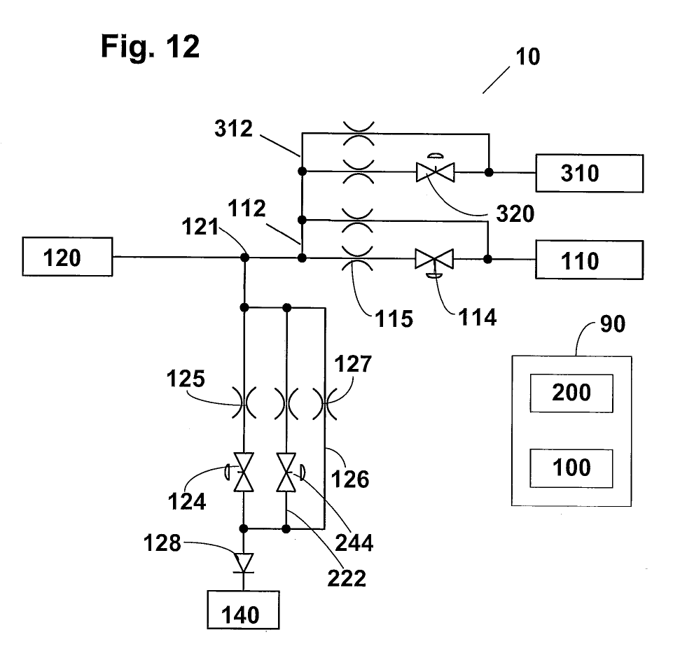

FIG. 12 illustrates a further embodiment. The embodiment of FIG. 12 is the same as that of FIG. 6 except as described below.

In FIG. 12 a further component 310 is provided with liquid by the liquid supply system 10. The same liquid source 120 is used. A further liquid flow path 312 to further component 310 is provided which is the same as the liquid flow path 112. In order to compensate for the flow resistance of the further liquid flow path 312 when the flow rate through that flow path is changed by varying the position of component valve 320, a further drain liquid flow path 222 is provided as in the embodiment of FIG. 10. Any change in the flow resistance of the further liquid flow path 312 can be compensated for by varying the flow resistance through the further drain liquid flow path 222.

Although the embodiment of FIG. 12 is based on the embodiment of FIG. 6, any other embodiment may be implemented in a multiple consumer or component embodiment. For example, the liquid supply described with reference to FIG. 9 could be a first component 110, the liquid supplied in the space 11 as illustrated in FIG. 5 could be a second component 310.

In an all wet immersion lithographic apparatus, liquid is supplied to the area outside of the space 11 (called the bulk liquid supply). This may be supplied through one or more types of outlet and each of those may be a component supplied by the liquid supply system of an embodiment of the present invention. The bulk liquid may be supplied at the radially outward edge of the liquid supply system 12 and/or at different positions on the substrate table. The flow rates to each component may be varied individually from a single liquid source 120 using the first controller 100. In the embodiment of FIG. 12 each consumer has an in-line branch and a drain valve. Each consumer in-line branch and drain valve is connected by a consumer controller having a switch so that when the valve in the in-line branch is open the drain valve would be closed and vice versa. The in-line branch of the different consumers are in parallel. In the drain branches, the branch valves 124, 224 and the by-pass line 126 are in parallel and lead to a single drain 140. The bulk liquid may have a separate source from the liquid supply arranged to supply liquid to the space 11.

Valves which are suitable for embodiments of the present invention include the Parker PV20, Gemü Clean Star® UHP PFA Valve C60 (AOV), Gemii Clean Star® UHP PFA Valve-Metal Free or the Entegris Integra.

As will be appreciated, any of the above described features can be used with any other feature and it is not only those combinations explicitly described which are covered in this application.

In an embodiment there is provided a fluid supply system for a lithographic apparatus, comprising a first controller. The first controller is configured to vary a fluid flow rate to a first component from a fluid source while maintaining total flow resistance to fluid flow downstream of the fluid source substantially constant.

The fluid supply system may further comprise a first fluid flow path between the fluid source and the first component. The fluid supply system may further comprise a first drain fluid flow path for the fluid to flow from a junction in the first fluid flow path to a drain component.

In an embodiment there is provided a fluid supply system for a lithographic apparatus comprising a first fluid path defined by a first fluid flow conduit connecting a fluid source to a first component, the system comprising: a junction and a first controller. The junction is in the first fluid flow conduit connecting the first fluid flow conduit to a drain component via a first drain fluid flow path. The first controller is configured to vary a fluid rate to the first component. The controller is configured to: vary the fluid rate in the first fluid flow conduit between the junction and the first component, vary the fluid rate in the first drain fluid flow path between the junction and the drain component, and maintain a substantially constant pressure in the fluid flow at the junction.

The fluid supply system may further comprise a first component valve in the first fluid flow path. The fluid supply system may further comprise a first by-pass line which connects the first fluid flow path upstream of the first component valve and the first fluid flow path downstream of the first component valve.

The fluid supply system may further comprise a first drain valve in the first drain fluid flow path. To vary the fluid flow rate to the first component, the first controller may adjust the first component valve and the first drain valve so as to vary the fluid flow rate through the first fluid flow path and the first drain fluid flow path while maintaining substantially constant total flow resistance to fluid downstream of the fluid source and/or maintaining substantially constant pressure in the fluid flow at the junction. The total flow resistance may be maintained substantially constant and/or the pressure in the fluid flow at the junction may be maintained substantially constant by opening the first drain valve or the first component valve and closing the other of the first drain valve and the first component valve.

The fluid supply system may further comprise a first drain by-pass line which connects the first drain fluid flow path upstream of the first drain valve and the first drain fluid flow path downstream of the first drain valve.

The fluid supply system may further comprise a further fluid flow path between the fluid source and the first component with a further component valve in the further fluid flow path and a corresponding further drain fluid flow path between the fluid source and the drain with a further drain valve in the further drain fluid flow path. The first controller may be configured to vary the fluid flow rate by adjusting one or more of the component valves and one or more of the corresponding drain valves so as to vary the fluid flow rate through the first fluid flow path and the first drain fluid flow path while maintaining substantially constant total flow resistance to fluid downstream of the fluid source.

The fluid supply system may further comprise a second fluid flow path between the fluid source and a second component. The fluid supply system may further comprise a second component valve in the second fluid flow path and a second by-pass line which connects the second fluid flow path upstream of the second component valve and the second fluid flow path downstream of the second component valve.

The fluid supply system may further comprise a second drain fluid flow path for fluid flow to the drain component from the fluid source or the junction and a second drain valve in the second drain fluid flow path. To vary the fluid flow rate to the second component, the first controller may adjust the second component valve and the second drain valve so as to vary the fluid flow rate through the second fluid flow path and the second drain fluid flow path while maintaining substantially constant total flow resistance to fluid downstream of the fluid source and/or maintaining substantially constant pressure in the fluid flow at the junction.

The drain component may be one selected from the group of: a component which needs to be supplied with fluid, a drain for the disposal of waste, or a recycling unit. The fluid supply system may further comprise a second controller configured to control the fluid source to supply fluid at a substantially constant pressure and/or substantially constant flow rate.

The fluid source may be configured to supply a liquid. The fluid supply system may comprise a liquid supply system.

In an embodiment there is provided a lithographic apparatus connected to the fluid supply system as herein described.

The lithographic apparatus may further comprise a fluid handling device to supply fluid between a final element of a projection system and a substrate, wherein the fluid handling system is connected to the fluid supply system.

In an embodiment there is provided a method of varying the fluid flow rate to a component from a fluid source, the method comprising adjusting a valve in a fluid flow path between the fluid source and the component while maintaining total flow resistance to fluid flow downstream of the fluid source substantially constant.

In an embodiment there is provided a method of varying the fluid flow rate to a component from a fluid source, the method comprising: varying the fluid rate in a fluid flow conduit between a junction, at which the fluid flow conduit is connected to a drain component via a drain fluid flow path, and the component; varying the fluid flow rate in the drain fluid flow path between the junction and the drain component; and maintaining a substantially constant pressure in the fluid flow at the junction.

In an embodiment there is provided a device manufacturing method, comprising projecting a patterned beam of radiation onto a substrate through a fluid provided in a space adjacent the substrate, and varying the fluid flow rate to the space using one or more methods herein described.

In an embodiment there is provided a fluid supply system for a lithographic apparatus comprising a first fluid path defined by a first fluid flow conduit connecting a fluid source to a first component, the system comprising: a junction and a controller. The junction is in the first fluid flow conduit connecting the first fluid flow conduit to a second component via a second fluid flow path. The controller is configured to vary the fluid rate to the first component. The controller is configured to: vary the fluid rate in the first fluid flow conduit between the junction and the first component, vary the fluid rate in the second fluid flow path between the junction and the second component, and maintain a substantially constant pressure in the fluid flow at the junction.

Although specific reference may be made in this text to the use of lithographic apparatus in the manufacture of ICs, it should be understood that the lithographic apparatus described herein may have other, applications, such as the manufacture of integrated optical systems, guidance and detection patterns for magnetic domain memories, flat-panel displays, liquid-crystal displays (LCDs), thin-film magnetic heads, etc. The skilled artisan will appreciate that, in the context of such alternative applications, any use of the terms “wafer” or “die” herein may be considered as synonymous with the more general terms “substrate” or “target portion”, respectively. The substrate referred to herein may be processed, before or after exposure, in for example a track (a tool that typically applies a layer of resist to a substrate and develops the exposed resist), a metrology tool and/or an inspection tool. Where applicable, the disclosure herein may be applied to such and other substrate processing tools. Further, the substrate may be processed more than once, for example in order to create a multi-layer IC, so that the term substrate used herein may also refer to a substrate that already contains multiple processed layers.

The terms “radiation” and “beam” used herein encompass all types of electromagnetic radiation, including ultraviolet (UV) radiation (e.g. having a wavelength of or about 365, 248, 193, 157 or 126 nm). The term “lens”, where the context allows, may refer to any one or combination of various types of optical components, including refractive and reflective optical components.

While specific embodiments of the invention have been described above, it will be appreciated that the invention may be practiced otherwise than as described. For example, the embodiments of the invention may take the form of a computer program containing one or more sequences of machine-readable instructions describing a method as disclosed above, or a data storage medium (e.g. semiconductor memory, magnetic or optical disk) having such a computer program stored therein. Further, the machine readable instruction may be embodied in two or more computer programs. The two or more computer programs may be stored on one or more different memories and/or data storage media.

The controllers described herein may each or in combination be operable when the one or more computer programs are read by one or more computer processors located within at least one component of the lithographic apparatus. The controllers may each or in combination have any suitable configuration for receiving, processing, and sending signals. One or more processors are configured to communicate with the at least one of the controllers. For example, each controller may include one or more processors for executing the computer programs that include machine-readable instructions for the methods described above. The controllers may include data storage medium for storing such computer programs, and/or hardware to receive such medium. So the controller(s) may operate according the machine readable instructions of one or more computer programs.

One or more embodiments of the invention may be applied to any immersion lithography apparatus, in particular, but not exclusively, those types mentioned above and whether the immersion liquid is provided in the form of a bath, only on a localized surface area of the substrate, or is unconfined. In an unconfined arrangement, the immersion liquid may flow over the surface of the substrate and/or substrate table so that substantially the entire uncovered surface of the substrate table and/or substrate is wetted. In such an unconfined immersion system, the liquid supply system may not confine the immersion liquid or it may provide a proportion of immersion liquid confinement, but not substantially complete confinement of the immersion liquid.

A liquid supply system as contemplated herein should be broadly construed. In certain embodiments, it may be a mechanism or combination of structures that provides a liquid to a space between the projection system and the substrate and/or substrate table. It may comprise a combination of one or more structures, one or more fluid openings including one or more liquid openings, one or more gas openings or one or more openings for two phase flow. The openings may each be an inlet into the immersion space (or an outlet from a fluid handling structure) or an outlet out of the immersion space (or an inlet into the fluid handling structure). In an embodiment, a surface of the space may be a portion of the substrate and/or substrate table, or a surface of the space may completely cover a surface of the substrate and/or substrate table, or the space may envelop the substrate and/or substrate table. The liquid supply system may optionally further include one or more elements to control the position, quantity, quality, shape, flow rate or any other features of the liquid.

The descriptions above are intended to be illustrative, not limiting. Thus, it will be apparent to one skilled in the art that modifications may be made to the invention as described without departing from the scope of the claims set out below.

1. A fluid supply system for a lithographic apparatus, comprising:
a first controller configured to vary a fluid flow rate to a first component from a fluid source while maintaining total flow resistance to fluid flow downstream of the fluid source substantially constant.

2. The fluid supply system of claim 1, further comprising a first fluid flow path between the fluid source and the first component.

3. The fluid supply system of claim 2, further comprising a first drain fluid flow path for the fluid to flow from a junction in the first fluid flow path to a drain component.

4. The fluid supply system of claim 3, further comprising a first component valve in the first fluid flow path.

5. The fluid supply system of claim 4, further comprising a first by-pass line which connects the first fluid flow path upstream of the first component valve and the first fluid flow path downstream of the first component valve.

6. The fluid supply system of claim 3, further comprising a first drain valve in the first drain fluid flow path.

7. The fluid supply system of claim 6, wherein to vary the fluid flow rate to the first component, the first controller adjusts the first component valve and the first drain valve so as to vary the fluid flow rate through the first fluid flow path and the first drain fluid flow path while maintaining substantially constant total flow resistance to fluid downstream of the fluid source and/or maintaining substantially constant pressure in the fluid flow at the junction.

8. The fluid supply system of claim 7, wherein the total flow resistance is maintained substantially constant and/or the pressure in the fluid flow at the junction is maintained substantially constant by opening the first drain valve or the first component valve and closing the other of the first drain valve and the first component valve.

9. The fluid supply system of claim 3, further comprising a first drain by-pass line which connects the first drain fluid flow path upstream of the first drain valve and the first drain fluid flow path downstream of the first drain valve.

10. The fluid supply system of claim 3, further comprising a further fluid flow path between the fluid source and the first component with a further component valve in the further fluid flow path and a corresponding further drain fluid flow path between the fluid source and the drain with a further drain valve in the further drain fluid flow path.

11. The fluid supply system of claim 10, wherein the first controller is configured to vary the fluid flow rate by adjusting one or more of the component valves and one or more of the corresponding drain valves so as to vary the fluid flow rate through the first fluid flow path and the first drain fluid flow path while maintaining substantially constant total flow resistance to fluid downstream of the fluid source.

12. The fluid supply system of claim 3, further comprising a second fluid flow path between the fluid source and a second component.

13. The fluid supply system of claim 12, further comprising a second component valve in the second fluid flow path and a second by-pass line which connects the second fluid flow path upstream of the second component valve and the second fluid flow path downstream of the second component valve.

14. The fluid supply system of claim 13, further comprising a second drain fluid flow path for fluid flow to the drain component from the fluid source or the junction and a second drain valve in the second drain fluid flow path.

15. A fluid supply system for a lithographic apparatus comprising a first fluid path defined by a first fluid flow conduit connecting a fluid source to a first component, the system comprising:
a junction in the first fluid flow conduit connecting the first fluid flow conduit to a drain component via a first drain fluid flow path; and
a first controller configured to varying a fluid rate to the first component, the controller configured to:
vary the fluid rate in the first fluid flow conduit between the junction and the first component,
vary the fluid rate in the first drain fluid flow path between the junction and the drain component, and
maintain a substantially constant pressure in the fluid flow at the junction.

16. A lithographic apparatus connected to a fluid supply system comprising a first controller configured to vary a fluid flow rate to a first component from a fluid source while maintaining total flow resistance to fluid flow downstream of the fluid source substantially constant.

17. A method of varying the fluid flow rate to a component from a fluid source, the method comprising adjusting a valve in a fluid flow path between the fluid source and the component while maintaining total flow resistance to fluid flow downstream of the fluid source substantially constant.

18. A method of varying the fluid flow rate to a component from a fluid source, the method comprising:
varying the fluid rate in a fluid flow conduit between a junction, at which the fluid flow conduit is connected to a drain component via a drain fluid flow path, and the component;
varying the fluid flow rate in the drain fluid flow path between the junction and the drain component; and
maintaining a substantially constant pressure in the fluid flow at the junction.

19. A device manufacturing method, comprising projecting a patterned beam of radiation onto a substrate through a fluid provided in a space adjacent the substrate, and varying the fluid flow rate to the space from a fluid source, the method comprising adjusting a valve in a fluid flow path between the fluid source and the component while maintaining total flow resistance to fluid flow downstream of the fluid source substantially constant.

20. A fluid supply system for a lithographic apparatus comprising a first fluid path defined by a first fluid flow conduit connecting a fluid source to a first component, the system comprising:
a junction in the first fluid flow conduit connecting the first fluid flow conduit to a second component via a second fluid flow path; and
a controller configured to vary the fluid rate to the first component, the controller configured to:
vary the fluid rate in the first fluid flow conduit between the junction and the first component,
vary the fluid rate in the second fluid flow path between the junction and the second component, and
maintain a substantially constant pressure in the fluid flow at the junction.
